(19) United States
(12) Patent Application Publication
(10) Pub. No.: US 2005/0149571 A1
(43) Pub. Date: Jul. 7, 2005

(54) Digital photographing apparatus and file managing method thereof

(75) Inventors: Young-jun Jeon, Seongnam-si (JP); Kyung-tai Nam, Seongnam-si (JP)

Correspondence Address: GARDNER CARTON & DOUGLAS LLP;ATTN: PATENT DOCKET DEPT., 191 N. WACKER DRIVE, SUITE 3700, CHICAGO, IL, 60606, US

(73) Assignee: Samsung Techwin Co., Ltd., Changwon-city (KR)

(21) Appl. No.: 11/016,071

(22) Filed: Dec. 17, 2004

(30) Foreign Application Priority Data
Dec. 30, 2003 (KR) 2003-100627

(51) Int. Cl. G06F 7/00

(52) U.S. Cl. 707/104.1

(57) ABSTRACT

Provided is a digital photographing apparatus in which information regarding a file to be deleted is moved to a temporary storage folder of a file storage unit and the file storage capacity of the temporary storing folder is displayed. Files in a digital photographing apparatus are managed by moving information regarding at least one file to be deleted to a temporary storage folder of a file storage unit, and deleting files of the temporary storage folder from the file storage unit.

### BACKGROUND OF THE INVENTION

This application claims the priority of Korean Patent Application No. 2003-100627, filed on Dec. 30, 2003, in the Korean Intellectual Property Office, the disclosure of which is incorporated herein in its entirety by reference.

1. Field of the Invention

The present invention relates to a digital photographing apparatus, for example, a digital camera, and a method of managing files thereof, and more particularly, to the management of files to be deleted from the digital photographing apparatus.

2. Description of the Related Art

In a typical digital photographing apparatus, for example, a digital camera disclosed in U.S. patent Publication No. 119,876 (Title of the invention: Method of Notification of Inadequate Picture Quality), a deleted file cannot be recovered. Accordingly, a plurality of steps for deletion confirmation procedures are required in deleting a file in the digital photographing apparatus.

According to the typical digital photographing apparatus, existing image files are deleted to provide storage space for newly photographed images. Consequently, even though there remains available storage space in memory after photographing, the already deleted files cannot be recovered.

### SUMMARY OF THE INVENTION

To solve the above and/or other problems, the present invention provides a digital photographing apparatus having a-file deletion function which is convenient to a user, by which a selected file is deleted from a memory card not immediately but only when predetermined conditions are met.

According to an aspect of the present invention, there is provided a digital photographing apparatus, wherein information for a file to be deleted is moved to a temporary storage folder of a file storage unit and the amount of storage space currently being used in the temporary storage folder is displayed.

According to another aspect of the present invention, there is provided a digital photographing apparatus, wherein, after a predetermined amount of time passes after a file to be deleted is moved to a temporary storage folder of the file storage unit, the files of the temporary storage folder are deleted from the file storage unit.

According to another aspect of the present invention, there is provided a digital photographing apparatus, wherein, when a predetermined amount of time passes after a file to be deleted is moved to a temporary storage folder of the file storage unit, the files of the temporary storage folder are deleted from the file storage unit on the condition that empty space of the file storage unit is not greater than a set value.

According to another aspect of the present invention, there is provided a digital photographing apparatus, wherein information regarding a file to be deleted is moved to a temporary storage folder of a file storage unit and the files of the temporary storage folder are deleted from the file storage unit according to an instruction of a user.

According to another aspect of the present invention, a digital photographing apparatus comprises: a storing portion where image files and an image management folder are stored, the image management folder including a first folder where information regarding files selected to be deleted from the image files are stored and a second folder where information regarding files that are not selected to be deleted is stored; a display portion that displays a thumbnail view of the image files in the storing portion by separating the files selected to be deleted from the images that are not selected to be deleted; a directional button to move a cursor on a thumbnail view image displayed on the display portion; a delete button for selecting, where the cursor is located, a thumbnail view image file to be deleted; and a restore button for restoring the file selected to be deleted, wherein the information regarding the file selected to be deleted is moved from the first folder to the second folder.

According to another aspect of the present invention, a digital photographing apparatus comprises: a storing portion where the image management folders are stored, the image management folders including a first folder where image files and information regarding files selected to be deleted from the image files is stored and a second folder where information is stored regarding files that are not selected to be deleted from the image files; a display portion for displaying a thumbnail view of image files stored in a file storage unit by separating the files selected to be deleted from the images that are not selected to be deleted; a directional button to move a cursor on a thumbnail view image displayed on the display portion; and a delete button for selecting where the cursor is located a thumbnail view image file to be deleted, wherein the information of the file selected to be deleted is moved from the second folder to the first folder.

According to another aspect of the present invention, a method of managing files in a digital photographing apparatus comprising moving information of at least one file to be deleted to a temporary storage folder of a file storage unit, and deleting files of the temporary storage folder from the file storage unit.

### BRIEF DESCRIPTION OF THE DRAWINGS

The above and other features and advantages of the present invention will become more apparent by describing in detail preferred embodiments thereof with reference to the attached drawings in which:

FIG. 1 is a block diagram illustrating the configuration of an exemplary digital photographing apparatus to which the concept of the present invention can be applied;

FIG. 2 is a flow chart for explaining a method of managing files performed in a digital photographing apparatus according to an embodiment of the present invention;

FIG. 3 is a flow chart for explaining a method of managing files of a digital photographing apparatus according to an embodiment of the present invention;

FIG. 4 is a flow chart for explaining a method of managing files of a digital photographing apparatus according to an embodiment of the present invention;

FIG. 5 is a flow chart for explaining an embodiment in which a condition to actually delete a file whose file information is stored in a trash folder, from a memory card;

FIG. 6 is a flow chart for explaining a method of managing files of a digital photographing apparatus according to another embodiment of the present invention;

FIG. 7 is a view illustrating a rear side of a camera to explain a process of selecting a file to be deleted in a playback mode of the digital photographing apparatus;

FIG. 8 is a view illustrating a screen for thumbnail view after the file of FIG. 7 is deleted;

FIGS. 9 and 10 are file management trees to explain the-file deletion process described in FIGS. 7 and 8, respectively;

FIG. 11 is a view illustrating an example of a screen indicating the number of images to be taken in a photographing mode of the digital photographing apparatus according to the present invention;

FIG. 12 is a view illustrating another example of a screen indicating the number of images to be taken in a photographing mode of the digital photographing apparatus according to the present invention;

FIG. 13 is a view illustrating an example of the file deletion process in the digital photographing apparatus according to the present invention, in which the file is deleted according to the instruction by a user;

FIG. 14 is a view illustrating an example of a file deletion process according to the instruction by a user in the digital photographing apparatus according to the present invention; and

FIG. 15 is a view illustrating yet another example of a screen indicating the number of images to be taken in a photographing mode of the digital photographing apparatus according to the present invention.

### DETAILED DESCRIPTION OF THE INVENTION

The configuration and operation of a digital photographing apparatus according to an embodiment of the present invention and a method of managing files thereof are described below in detail with reference to the accompanying drawings. The same reference numerals in the respective drawings denote constituent elements having the same functions.

The basic concept of the present invention is to not immediately delete a file selected to be deleted from a digital photographing apparatus. For this purpose, a concept of a folder where information regarding the file selected to be deleted is temporarily stored is adopted herein. Hereinafter, the temporary storage folder is referred to as a trash folder. In the present invention, when the files whose information is stored in the trash folder correspond to a predetermined condition, the files are deleted from the file storage unit. The file storage unit may be a memory card or a flash memory.

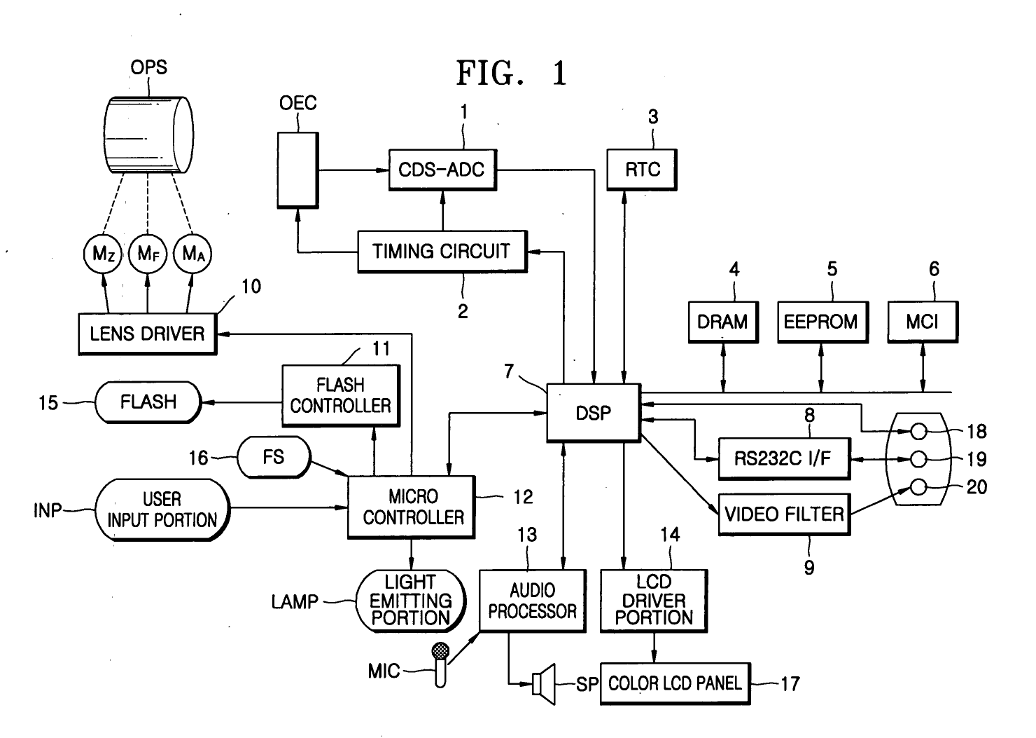

FIG. 1 is a block diagram illustrating the configuration of an exemplary digital photographing apparatus to which the concept of the present invention can be applied. Referring to FIG. 1, an optical system OPS including a lens portion and a filter portion optically processes light from an object to be photographed. The lens portion in the OPS includes a zoom lens, a focus lens, and a compensation lens.

An optical-electrical converter (OEC) of a charge coupled device (CCD) or a complementary metal-oxide-semiconductor (CMOS) converts the light from the OPS into an electrical analog signal. A digital signal processor (DSP) 7 controls a timing circuit 2 to control the operation of the OEC and a correlation double sampler and analog-to-digital converter (CDS-ADC) 1. The CDS-ADC 1 processes an analog signal from the OEC to convert it to a digital signal, by removing high frequency noise and adjusting amplitude thereof. The DSP 7 processes the digital signal from the CDS-ADC 1 to generate a digital video signal divided into luminance and chrominance signals.

A dynamic random access memory (DRAM) 4 temporarily stores the digital video signal from the DSP 7. An electrically erasable programmable read only memory (EEPROM) 5 stores algorithm and setting data needed for the operation of the DSP 7. A user's memory card is inserted in or detached from a memory card interface 6.

The digital video signal from the DSP 7 is input to an LCD driving portion 14 and thus an image is displayed on a color LCD panel 17. The digital video signal from the DSP 7 can be transmitted in a serial communication through a universal serial bus (USB) connection portion 18, or an RS232C interface (RS232C I/F) 8 and a connection portion 19, or as a video signal through a video filter 9 and a video output portion 20.

An audio processor 13 outputs a voice signal from a microphone (MIC) to the DSP 7 or a speaker SP and an audio signal from the DSP 7 to the speaker SP.

A user input portion INP includes a shutter button, a mode selection button, a function selection button, a zoom button, and directional movement buttons. The user input portion INP is operated by a user to generate commands to perform each function according to the instruction by the user.

A microcontroller 12 controls a lens driving portion 10 and accordingly a zoom motor M_{Z}, a focus motor M_{F}, and an aperture motor M_{A} drive a zoom lens, a focus lens, and an aperture, respectively. A light emitting portion LAMP driven by the microcontroller 12 includes a self-timer lamp, an auto-focus lamp, and a flash ready lamp. The microcontroller 12 drives a flash 15 by controlling the operation of a flash controller 11 according to a signal output from a flash light amount sensor 16.

The digital photographing apparatus according to the present invention does not need to have all constituent elements of FIG. 1. Those skilled in the art can understand that part of the constituent elements can be removed, other constituent elements added, or some constituent elements modified.

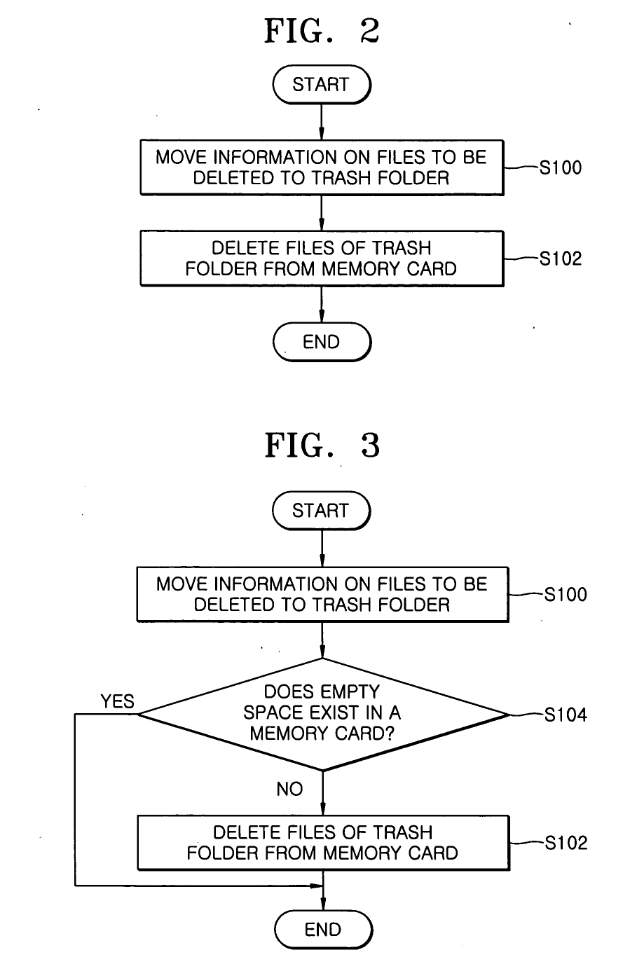

FIG. 2 is a flow chart for explaining a method of managing files performed in a digital photographing apparatus according to an embodiment of the present invention. Referring to FIG. 2, in the method of managing files of a digital photographing apparatus according to an embodiment of the present invention, information regarding files to be deleted is moved to a trash folder (S100). The files of the trash folder are deleted from a memory card (S102). The step S100 is executed when the files to be deleted are selected by the user. Thus, after the digital photographing apparatus is turned on, the step S100 is not always executed and when files already exist in the trash folder, the step S102 can be directly executed.

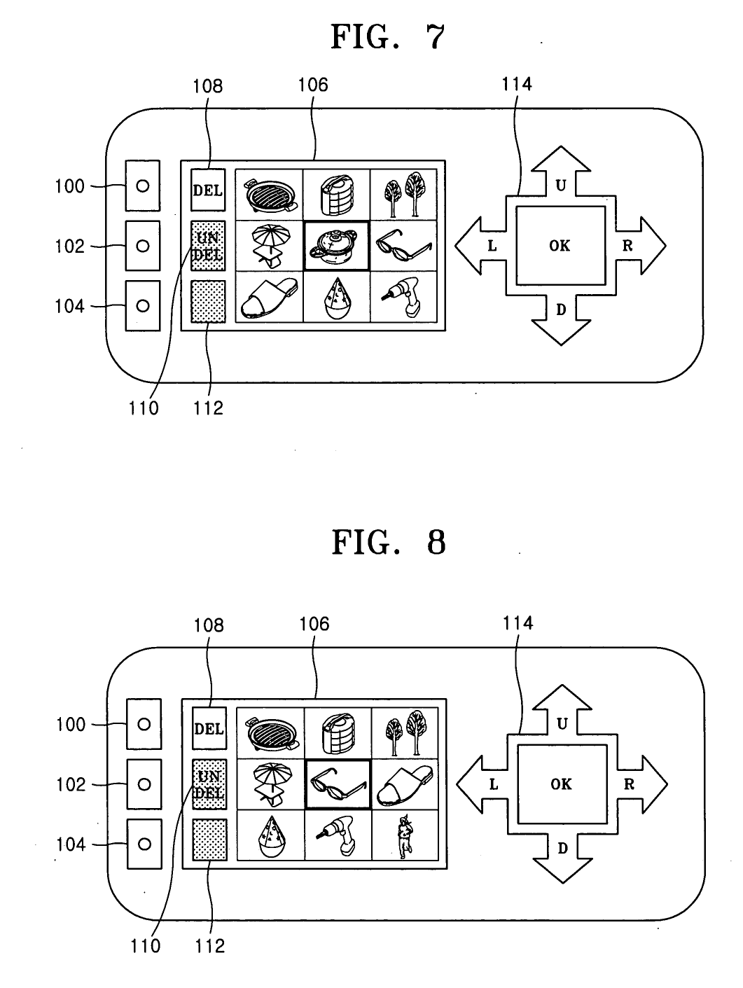

FIG. 7 illustrates the rear side of a camera to explain a process of selecting a file to be deleted in a playback mode of the digital photographing apparatus. A storing portion (not shown), a delete button 100, a restore button 102, a display 106, and a directional button 114 are provided on the rear side of the camera.

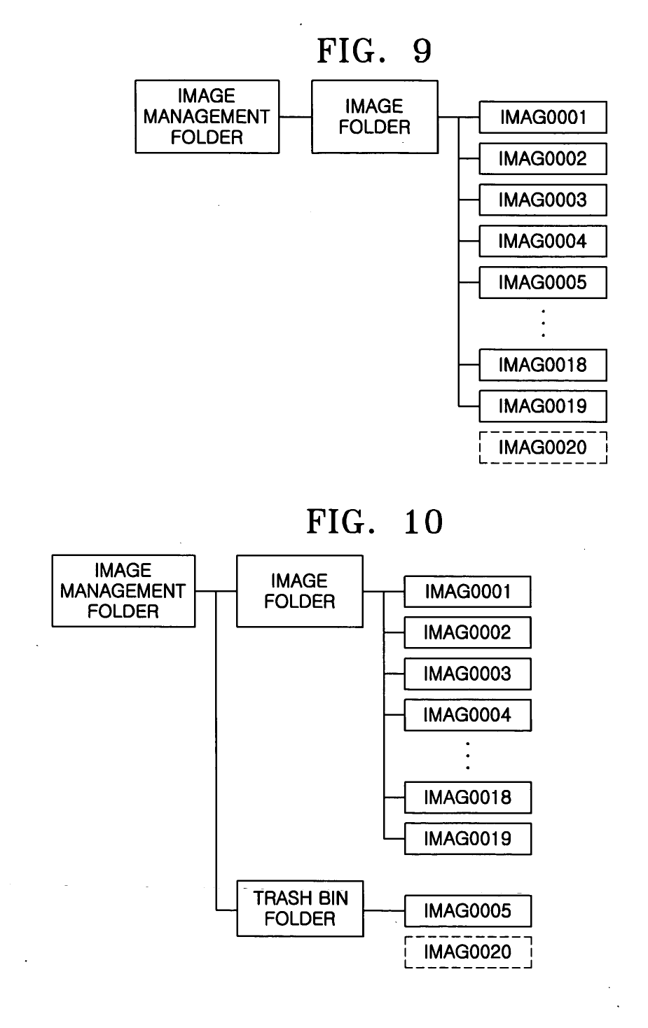

Although it is not shown in the drawing, the storing portion stores image files in an image management folder which includes a trash folder where information is stored on files selected to be deleted from the image files and an image folder where information is stored on files that are not selected to be deleted. The storing portion can be formed of a memory card or a flash memory. The image management folder will be described in FIGS. 9 and 10.

The display portion 106 displays the image files stored in the storing portion in a thumbnail view by dividing the files into those selected to be deleted and those that are not selected to be deleted. Referring to FIG. 7, a thumbnail view displaying nine-images is an example-of a thumbnail view screen. FIG. 8 illustrates a thumbnail screen after a file is deleted.

The directional button 114 is operated by the-user to move a cursor on the thumbnail view image displayed on the display portion 106. The-delete button 100, when operated by the user, deletes the image file that the cursor is positioned on in the thumbnail view. The restore button 102 is operated by the user to restore the deleted file.

As the user presses the delete button, the file information selected to be deleted is moved in the image management folder of the storing portion from the image folder to the trash folder.

A playback button 104 is operated by the user to reproduce a thumbnail view of the image file where the cursor is positioned. A playback mark 112 indicates to the user whether the playback button 104 is available. The playback button 104 and the playback mark 112 are not essential to the present invention.

Referring to FIG. 7, the process of selecting a file is described as follows. The user moves a cursor on the thumbnail view screen of the display portion 106 to the position of a file to be deleted, by using up (U), down (D), left (L), and right (R) of the directional button 114. The cursor indicates a boundary as shown in the drawing to distinguish the file to be deleted from other files. The cursor can be moved up and down, and left and right, by the-directional button 114. FIG. 7 shows a state in which the cursor is positioned at the fifth file which is a photograph of a “pot”. The display portion 106 displays the activated state 108 of the delete button 100 and the deactivated state 110 of the restore button 102. The activated button performs a function by the operation of the user and the deactivated button does not perform a function by the operation of the user. In FIG. 7, by displaying “DEL” (108) brighter and “UNDEL” (110) darker, it can be seen that the delete button 100 and the restore button 102 are in the activated and deactivated modes, respectively in this example. In FIG. 7, when the cursor is positioned on the fifth file of the “pot” and the delete button 100 is activated, the fifth file is selected to be deleted by pressing the delete button 100. When the file is selected to be deleted, the file is not deleted instantly. Instead, the file information is moved to the trash folder.

FIG. 8 shows the thumbnail view screen after the fifth file has been selected to be deleted in FIG. 7. The file selected to be deleted disappears from the screen and the next file moves to the left and up. The cursor remains positioned at the fifth file.

The selection of a file to be deleted is performed in a two-step manner by first selecting a file using a selection button OK included in the directional button 114 and second, by pressing the delete button 100 to finally select the file to be deleted.

FIGS. 9 and 10 illustrate a file management tree to explain a file deleting process described with reference to FIG. 7 and 8. Referring to FIGS. 9 and 10, the file management tree includes an image management folder. The image management folder includes an image folder and a trash folder. The file management tree of FIGS. 9 and 10 is an example of a file tree of the storing portion where 20 image files can be stored.

Referring to FIG. 9, nineteen image files IMAG0001-IMAG0019 are stored in the memory card of the digital photographing apparatus and empty space capable of storing one image file IMAG0020 exists.

In FIGS. 7 and 8, only nine of the nineteen image files of FIGS. 9 and 10 are displayed on the thumbnail view screen.

Referring to FIG. 10, the fifth file IMAG0005 has been selected to be deleted and the information regarding the fifth file has been moved to the trash folder. Thus, the empty space for one image file storage capacity and the capacity for one file in the trash folder that is selected to be deleted exist in the memory card. The digital photographing apparatus displays the capacity of the empty space in the image folder and the file storage of the trash folder to the user.

FIG. 3 is a flow chart for explaining a method of managing files in the digital photographing apparatus according to an embodiment of the present invention. Referring to FIG. 3, the information regarding a file to be deleted is moved to the trash folder (S100). Next, whether there is empty space in the memory card is determined (S104). If there is empty space in the memory card, the file management method of FIG. 3 is terminated. If no empty space is left in the memory card, the file in the trash folder is deleted from the memory card (S102). Whether the empty space exists in the memory card is determined according to whether the minimum space for photographing exists.

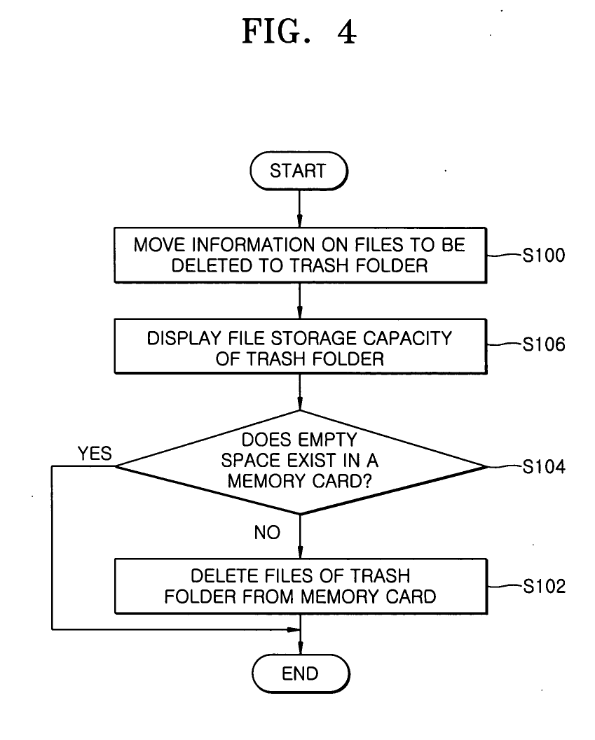

FIG. 4 is a flow chart for explaining a method of managing files in the digital photographing apparatus according to the embodiment of the present invention. Referring to FIG. 4, information regarding the file to be deleted is moved to the trash folder (S100). After the step S100, the file storage-capacity of the trash folder is displayed (S106). In the conventional digital photographing apparatus, the number of images to be taken merely indicates a physical empty space of a memory card. However, in the present invention, the file storage capacity of the trash folder can be displayed.

In the step S106, the file storage capacity of the trash folder can be calculated based on the capacity itself or by calculating the number of images to be taken. Also, the file storage capacity of the trash folder can be added to the storage capacity of the empty space of the image folder of the memory card, and the resulting total can be displayed. Furthermore, the file storage capacity of the trash folder can be displayed separately from the storage capacity of the image folder of the memory card. The file storage capacity of the trash folder can be set differently according to photographing modes. In a picture photographing mode, a set value can be determined by calculating the number of images to be taken. In a motion picture photographing mode or a sound recording mode, the set value can be determined by calculating the time available for photographing or recording sound.

Next, whether an empty space exists in the memory card is determined (S104). When the empty space exists in the memory card, the method of FIG. 4 is terminated. When the empty space does not exist in the memory card, files of the trash folder are deleted from the memory card (S102). The existence of the empty space in the memory card can be determined by whether a minimum space for photographing exists or not.

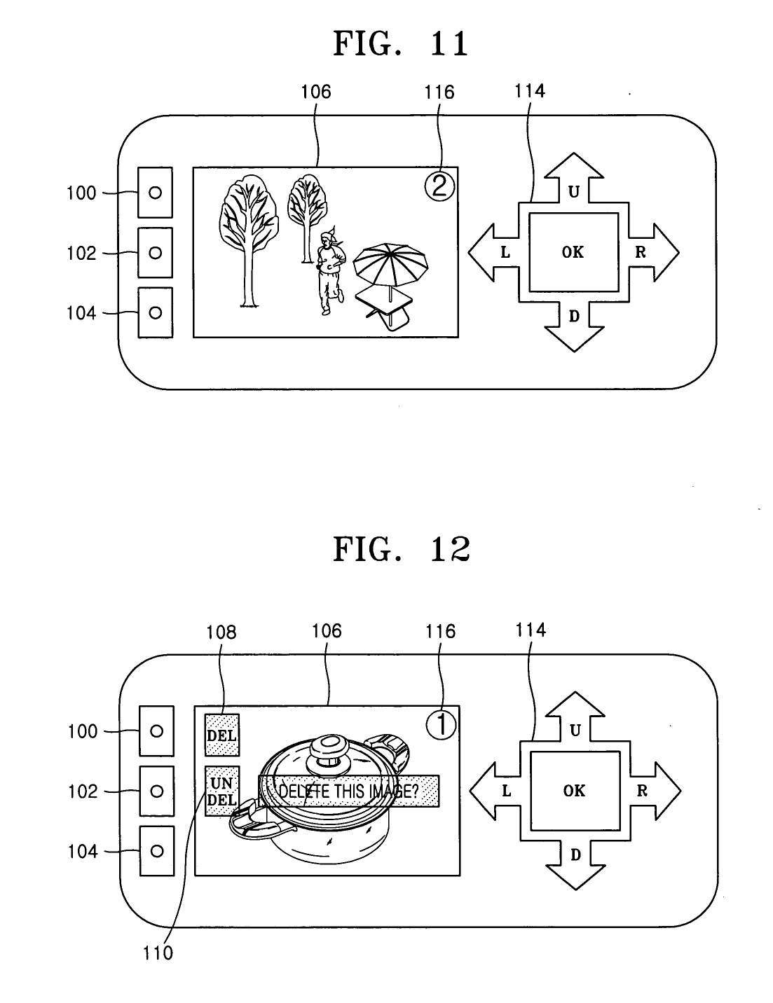

FIG. 11 shows an example of a screen displaying the number of images to be taken in the photographing mode of the digital photographing apparatus according to the present invention. Referring to FIG. 11, the number “2” displayed at the upper right corner of the screen in the photographing mode indicates the number of images to be taken. In the conventional digital photographing apparatus, the number of images to be taken merely indicates only the physical empty space of the memory card. In the present invention, however, the number of images to be taken can be displayed by summing the file storage capacity of the trash folder and the physical empty space of the image folder of the memory card.

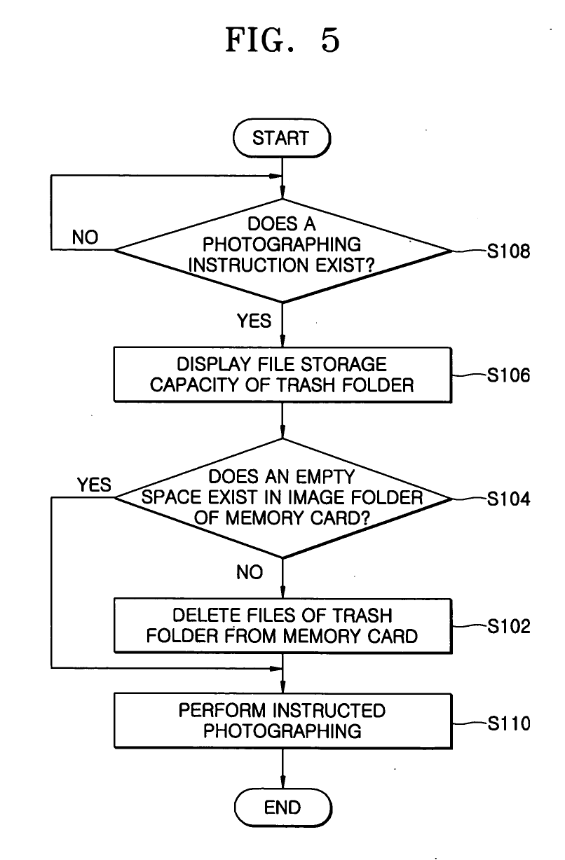

Assuming that the information regarding a file selected to be deleted is stored in the trash folder, FIG. 5 is a flow chart for explaining an embodiment of a condition to actually delete from a memory card such a file. Referring to FIG. 5, whether a photographing instruction exists is continuously checked (S108). The file storage capacity of the trash folder is displayed (S106). Whether an empty space of the memory card exists is determined (S104). When empty space does not exist in the memory card, a file of the trash folder is deleted from the memory card (S102). The photographing instruction is performed (S110).

The photographing instruction in the step S108 may be a picture photographing instruction, a motion picture photographing instruction, or a sound recording instruction. The file storage display format of the trash folder in step S106 may vary according to the type of the photographing instruction. That is, the file storage capacity of the trash folder can be displayed as the number of images to be taken with respect to a picture photographing instruction, as photographing time available with respect to a motion picture photographing instruction, and as sound recording time available with respect to a sound recording instruction.

Step S108 is a condition to delete the file from the memory card. Although the photographing instruction described in step S108 in FIG. 5 is the passing of a predetermined time, alternatively, the empty space of the memory card not being greater than a set value or the user's instruction can also be the condition in step S108 to delete files.

The passing of a predetermined time as the condition to delete files, for example, can be passing of time in units of hours such as “one hour passed” or “two hours passed” after the file information is moved to the-trash folder. Also, the passing of a predetermined time as the condition to delete files can be in units of days such as “one day passed” or “two days passed” after the file information is moved to the trash folder.

The concept of deleting files after a predetermined time passes includes the concept of a predetermined time point after the file information is moved to the trash folder. For example, when the time point to delete files is set as noon every day, files whose information is moved to the trash folder in the afternoon today are deleted from the memory card tomorrow at noon.

The digital photographing apparatus can also be embodied such that, when the empty space of the memory card is not greater than a set value, the files of the trash folder are deleted from the memory card. When the empty space of the memory card is not greater than the set value, all files of the trash folder are deleted at one time. Also, files of the trash folder can be selectively deleted so that the empty space in the trash folder becomes over the set value. For example, when the number of images to be taken in the empty space of the memory card is 0, files of the trash folder, i.e. files whose information is currently in the trash folder, can be deleted so that the number of images available to be taken becomes, for example, 3. When only one file exists in the trash folder, only that file is deleted. When four files exist in the trash folder, three of the four files are deleted. The digital photographing apparatus can also be embodied such that, when the empty space of the memory card is not greater than the set value, the files of the trash folder are deleted from the memory card according to the instruction by a user. Alternatively, the empty space storage capacity or the files to be selected can be determined according to the instruction by a user.

When the file deletion condition is set as the empty space of the memory card not being greater than a set value, the set value can be set differently according to the photographing mode. The set value can be determined by being calculated into the number of images to be taken. For the motion picture photographing mode or the sound recording mode, the set value is determined by being calculated into the photographing or recording time available.

When the file deletion condition is an instruction by the user, it can be input by the user using the delete button 100, for example, provided on the digital photographing apparatus or using an application program in a personal computer connected to the digital photographing apparatus.

The instruction by the user can be embodied in combination with other file deletion conditions. For example, after a predetermined time passes after file information is moved to the trash folder, whether the files of the trash folder are to be deleted from the memory card is displayed on the display portion 106 and then the files are deleted when the user presses the delete button 100. When the empty space of the memory card is set to be not greater than the set value, whether the files of the trash folder are to be deleted from the memory card is displayed on the display portion 106 and then the files are deleted when the user presses the delete button 100.

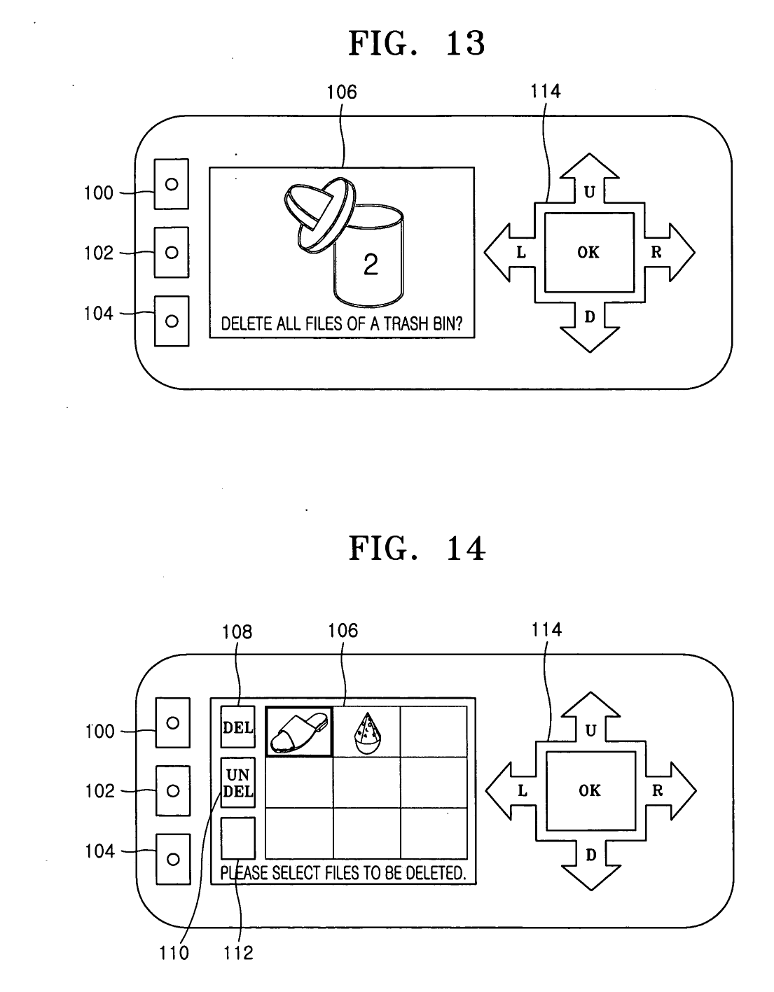

FIG. 12 is a view illustrating another example of a screen indicating the number of images to be taken in a photographing mode of the digital photographing apparatus according to the present invention.. FIG. 13 is a view showing a state in which the user tries to photograph another image after an image is photographed.

The digital photographing apparatus can -display the files of the trash folder on the display portion 106 according to the user's set state and then display a guide text such as “Delete this image?”. When the user presses the delete button 100, the corresponding file is deleted.

The digital photographing apparatus can be embodied such that, when the user tries to photograph a new image after photographing an image, the step shown in FIG. 12 is omitted and the files of the trash folder are directly deleted. When the user presses the restore button 102 before the file of the trash folder is deleted, the file information in the trash folder are moved to the image folder and the number of images, to be taken is displayed as “0” and a sign or text indicating that more photographing is not available can be displayed on the display portion 106.

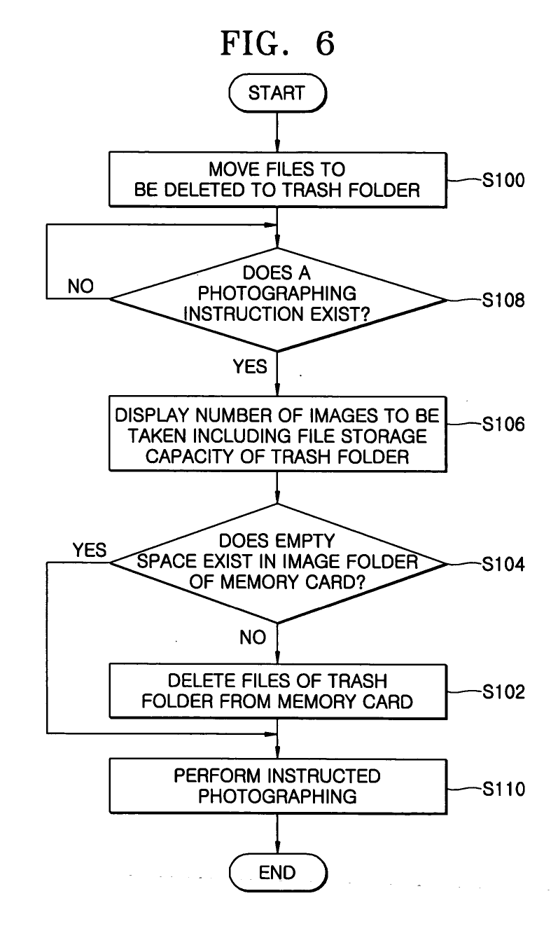

FIG. 6 is a flow chart for explaining a method of managing files of a digital photographing apparatus according to another embodiment of the present invention. Referring to FIG. 6, the information regarding files to be deleted is moved to the trash folder (S100). Whether a photographing instruction exists is continuously checked (S108). The file storage capacity of the trash folder is displayed (S106). Whether an empty space exists in the memory card is determined (S104). If the empty space does not exist in the memory card, the files of the trash folder are deleted from the memory card (S102). When the empty space exists in the memory card or after step S102, instructed photographing is performed (S110).

In FIG. 6, the step S100 can be performed in the playback mode while the steps S108 through S110 can be performed in the photographing mode.

FIG. 13 is a view illustrating an example of the file deletion process in the digital photographing apparatus according to the present invention, in which the file is deleted according to the instruction by a user. Referring to FIG. 13, when the condition to delete the files of the trash folder from the memory card is established, the file storage capacity of the trash folder is displayed on the display portion 106. In FIG. 13, the number “2” at the center of a trash bin indicates the number of files of the trash folder that could be deleted. A guide text such as “Delete all files in the trash bin?” can be further displayed on the display portion 106. When the user presses the delete button 100, the files of the trash folder are all deleted from the memory card.

The file storage capacity of the trash folder can be displayed differently according to the photographing modes. In the picture photographing mode, the number of images to be taken can be displayed as the file storage capacity of the trash folder as shown in FIG. 13. Although it is not shown in the drawing, in the motion picture photographing mode, the photographing time available can be displayed as the as the file storage capacity of the trash folder. Although it is not shown in the drawing, in the sound recording mode, the sound recording time available can be displayed as the as the file storage capacity of the trash folder.

FIG. 14 is a view illustrating an example of a file deletion process according to the instruction by a user in the digital photographing apparatus according to the present invention. Referring to FIG. 14, when the condition to delete files of the trash folder from the memory card is established, the files of the trash folder are displayed on the display portion 106 in a thumbnail view. A guide text such as “Please select files to be deleted” can be further displayed on the display portion 106. When the user manipulates the directional button 114 to move a cursor to a desired file position and presses the delete button 100, the files of the trash folder are deleted from the memory card.

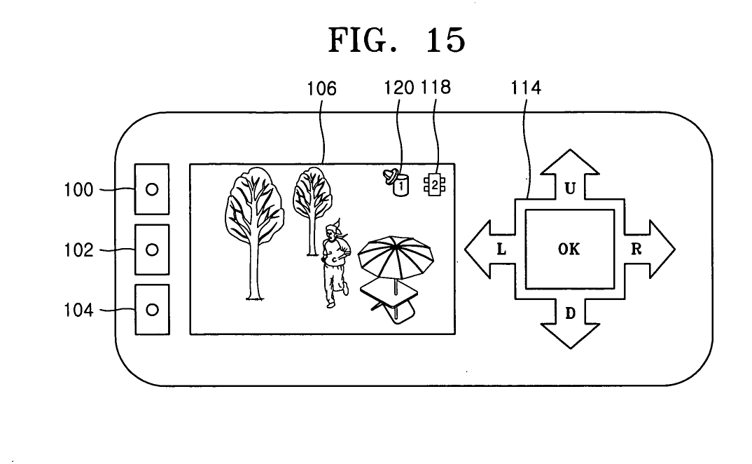

FIG. 15 is a view illustrating yet another example of a screen indicating the number of images to be taken in a photographing mode of the digital photographing apparatus according to the present invention. In FIG. 11, the number of images to be taken is displayed by summing the file storage capacity of the trash folder and the empty space of the image folder of the memory card. In contrast, in FIG. 15, information that one image is available in the trash folder 120 and two images 118 are available in the empty space of the image folder of the memory card is displayed. Although in the drawing the number of images to be taken is displayed as a memory capacity, assuming the picture photographing mode, the motion picture photographing available time or the sound recording available time can be displayed according to the photographing modes.

In the above-described embodiments, a memory card is used as-a storing unit, but the present invention is not limited thereto. Those skilled in the art can understand that a flash card, for example, can be used as-the storing unit.

The invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion. Also, functional programs, codes, and code segments for accomplishing the present invention can be easily construed by programmers skilled in the art to which the present invention pertains.

As described above, in the digital photographing apparatus according to the present invention, the files selected to be deleted are not immediately deleted from the memory card, but deleted from the memory card when a predetermined condition is satisfied. Also, the temporarily deleted files can be restored as necessary. Thus, the selection of files to be deleted is simple and the files deleted in error can be restored.

While this invention has been particularly shown and described with reference to preferred embodiments thereof, it will be understood by those skilled in the art that various changes in form and details may be made therein without departing from the spirit and scope of the invention as defined by the appended claims.

1. A digital photographing apparatus comprising:
a file storage unit wherein information relating to a file to be deleted is moved to a temporary storage folder of the file storage unit; and
a display for displaying the file storage capacity of the temporary storing folder.

2. The digital photographing apparatus as claimed in claim 1, wherein the file storage capacity of the temporary storage folder is displayed as the number of images available to be taken.

3. The digital photographing apparatus as claimed in claim 1, wherein the file storage capacity of the temporary storage folder is displayed as, the photographing time available.

4. The digital photographing apparatus as claimed in claim 1, wherein the file storage capacity of the temporary storage folder is displayed as the sound recording time available.

5. The digital photographing apparatus as claimed in claim 1, wherein the sum of the file storage capacity of the temporary storage folder and the remaining storage capacity of the available space in the file storage unit is displayed.

6. The digital photographing apparatus as claimed in claim 1, wherein the file storage capacity of the temporary storage folder and the storage capacity of the remaining available space in the file storage unit are separately displayed.

7. A digital photographing apparatus comprising a file storage unit wherein, when a predetermined time passes after information regarding a file to be deleted is moved to a temporary storage folder of the file storage unit, the files of the temporary storage folder are deleted from the file storage unit.

8. The digital photographing apparatus as claimed in claim 7, wherein, when a predetermined time passes after information relating to a file to be deleted is moved to the temporary storage folder of the file storage unit, the files of the temporary storage folder are deleted from the file storage unit according to an instruction by a user.

9. A digital photographing apparatus comprising a file storage unit wherein, when a predetermined time passes after information relating to a file to be deleted is moved to a temporary storage folder of a file storage unit, the files of the temporary storage folder are deleted from the file storage unit on a condition that the available space of the file storage unit is not greater than a set value.

10. The digital photographing apparatus as claimed in claim 9, wherein all files of the temporary storage folder are deleted at once from the file storage unit.

11. The digital photographing apparatus as claimed in claim 9, wherein the files of the temporary storage folder are selectively deleted at once from the file storage unit so that the available storage space of the file storage unit after the files are deleted is not less than the set value.

12. The digital photographing apparatus as claimed in claim 9, wherein, when the available storage space of the file storage unit is not greater than a set value, the files of the temporary storage folder are deleted from the file storage unit according to an instruction by a user.

13. The digital photographing apparatus as claimed in claim 12, wherein, when the available storage space of the file storage unit is not greater than a set value, all files of the temporary storage folder are deleted at once from the file storage unit according to an instruction by a user.

14. The digital photographing apparatus as claimed in claim 12, wherein, when the available storage space of the file storage unit is not greater than a set value, the files of the temporary storage folder are selectively deleted from the file storage unit according to an instruction by a user.

15. A digital photographing apparatus comprising a file storage unit, wherein when information relating to a file to be deleted is moved to a temporary storage folder of the file storage unit, the files of the temporary storage folder are deleted from the file storage unit according to an instruction by a user.

16. The digital photographing apparatus as claimed in claim 15, wherein all files of the temporary storage folder are deleted at once from the file storage unit according to an instruction of the user.

17. The digital photographing apparatus as claimed in claim 1, wherein the files of the temporary storage folder are selectively deleted from the file storage unit according to the instruction of the user.

18. A digital photographing apparatus comprising:
a storing portion where image files and an management folder are stored, the image management folder including a first folder where information regarding files selected to be deleted from the image files is stored and a second folder where information relating to files that are not selected to be deleted is stored;
a display for displaying the image files stored in the storing portion in a thumbnail view image method by separating the image files that are selected to be deleted from the image files that are not selected to be deleted;
a directional input mechanism that moves a cursor on the thumbnail view image displayed on the display;
a delete input mechanism for selecting a thumbnail view image file to be deleted where the cursor is located; and
a restore input mechanism for restoring the file selected to be deleted, wherein the information relating to the file selected to be deleted is moved from the second folder to the first folder.

19. The digital photographing apparatus as claimed in claim 18, wherein, when the cursor is located on the file selected to be deleted, the restore input mechanism is activated and the delete input mechanism is deactivated.

20. The digital photographing apparatus as claimed in claim 19, wherein the display portion displays activation or deactivation of the delete input mechanism and the restore input mechanism.

21. The digital photographing apparatus as claimed in claim 18, wherein, when the cursor is located on the file that is not selected to be deleted, the restore input mechanism is deactivated and the delete input mechanism is activated.

22. The digital photographing apparatus as claimed in claim 21, wherein the display portion displays activation or deactivation of the delete input mechanism and the restore input mechanism.

23. The digital photographing apparatus as claimed in claim 18, wherein the first folder is generated when at least one file is selected to be deleted.

24. A digital photographing apparatus comprising:
a storing portion where image files and an management folder are stored, the image management folder including a first folder where information regarding files selected to be deleted from the image files is stored and a second folder where information is stored relating to files that are not selected to be deleted from the image files;
a display for displaying a thumbnail view of the image files stored in the file storage unit by separating the files selected to be deleted from the image files that are not selected to be deleted;
a directional input mechanism to move a cursor on a thumbnail view image displayed on the display; and
a delete input mechanism for selecting the thumbnail view image file to be deleted where the cursor is located,
wherein the information of the file selected to be deleted is moved from the second folder to the first folder.

25. The digital photographing apparatus as claimed in claim 24, wherein the display displays a delete function of the delete input mechanism.

26. The digital photographing apparatus as claimed in claim 24, wherein, when the cursor is located on the file selected to be deleted, the delete input mechanism is switched to have a function to restore the file selected to be deleted.

27. The digital photographing apparatus as claimed in claim 26, wherein the display displays a restoring function of the delete input mechanism.

28. The digital photographing apparatus as claimed in claim 24, wherein the first folder is generated when at least one file is selected to be deleted.

29. A method of managing files in a digital photographing apparatus comprising:
moving information relating to at least one file to be deleted to a temporary storage folder of a file storage unit; and
deleting files of the temporary storage folder from the file storage unit.

30. The method as claimed in claim 29, further comprising determining whether available storage space exists in the file storage unit, wherein, in the deleting of files of the temporary storage folder from the file storage unit, the files are deleted when the available storage space does not exist in the file storage unit.

31. The method as claimed in claim 29, further comprising displaying the file storage capacity of the file storage unit.

32. The method as claimed in claim 31, wherein, in the displaying of the file storage capacity, the number of images to be taken is displayed as the file storage capacity.

33. The method as claimed in claim 31, wherein, in the displaying of the file storage capacity, a photographing available time is displayed as the file storage capacity.

34. The method as claimed in claim 31, wherein, in the displaying of the file storage capacity, a sound recording available time is displayed as the file storage capacity.

35. The method as claimed in claim 31, wherein, in the displaying of the file storage capacity, the file storage capacity of the temporary storage folder and a storage capacity of available storage space of the file storage unit are displayed.

36. The method as claimed in claim 35, wherein, in the displaying of the file storage capacity, a sum of the file storage capacity of the temporary storage folder and a storage capacity of available storage space of~the file storage unit is displayed.

37. The method as claimed in claim 35, wherein, in the displaying of the file storage capacity, the file storage capacity of the temporary storage folder and the storage capacity of available storage space of the file storage unit are separately displayed.

38. The method as claimed in claim 29, wherein the deleting of files of the temporary storage folder from the file storage unit is performed when there is a photographing instruction by a user.

39. The method as claimed in claim 30, wherein the determining of the existence of available storage space in the file storage unit is performed when there is an instruction by a user, and further comprising performing instructed photographing when the available storage space is determined to exist in the file storage unit or after the deleting of files of the temporary storage folder from the file storage unit.

40. The method as claimed in claim 29, wherein deleting files of the temporary storage folder from the file storage unit, all files of the temporary storage folder are deleted at once from the file storage unit.

41. The method as claimed in claim 29, wherein deleting files of the temporary storage folder from the file storage unit, as many files of the temporary storage folder as necessary are selectively deleted from the file storage unit.

42. The method as claimed in claim 29, wherein deleting files of the temporary storage folder from the file storage unit, the files of the temporary storage folder are deleted from the file storage unit according to an instruction by a user.

43. The method as claimed in claim 42, wherein deleting files of the temporary storage folder from the file storage unit, all files of the temporary storage folder are deleted at once from the file storage unit according to an instruction by a user.

44. The method as claimed in claim 42, wherein deleting files of the temporary storage folder from the file storage unit, the files of the temporary storage folder are selectively deleted from the file storage unit according to an instruction by a user.

45. A computer readable recording medium containing a program that performs the steps comprising:
moving information relating to at least one file to be deleted to a temporary storage folder of a file storage unit; and
deleting the files of the temporary storage folder from the file storage unit.

46. A computer readable recording medium as claimed in claim 45, wherein the program performs a further step of determining whether available storage space exists in the file storage unit and deleting files of the temporary storage folder from the file storage unit when available storage space does not exist.

47. A computer readable recording medium as claimed in claim 45 wherein the program performs a further step of displaying the number of images to be taken as the file storage capacity.
